(19) United States
(12) Patent Application Publication
(10) Pub. No.: US 2011/0120807 A1
(43) Pub. Date: May 26, 2011

(54) INDUSTRIAL TRUCK COMPRISING TWO LOAD CARRIAGES

(75) Inventors: Magnus Persson, Sturefors (SE); Bjorn Hedberg, Mjolby (SE)

(73) Assignee: BT PRODUCTS AB, Mjolby (SE)

(21) Appl. No.: 13/055,252

(22) PCT Filed: Aug. 18, 2009
(86) PCT No.: PCT/EP09/60688

§ 371 Date: Jan. 21, 2011

(30) Foreign Application Priority Data
Aug. 27, 2008 (EP) 08163069.1

(51) Int. Cl. B66F 9/075; B66F 9/12; B66F 9/08

(52) U.S. Cl. 187/237

(57) ABSTRACT

The invention relates to an industrial truck comprising a first mast comprising two uprights and a first and a second load carriage arranged to be independently moved in the vertical direction wherein a second mast is arranged between the uprights of the first mast and that the first load carriage is arranged to be moved along the first mast and the second load carriage is arranged to be moved along the second mast.

### TECHNICAL FIELD

The present invention relates to an industrial truck comprising two load carriages which can be independently moved on two separate masts.

### BACKGROUND ART

In warehouses, goods are normally unloaded and placed into pallet racks until needed for selling or further processing. When an order arrives, a stacking truck is sent out to pick up the goods and deliver them for further transport or processing. The handling of goods in this way is very labor intensive, since every delivery and pick up order demands the operation of one truck and one driver.

In order to increase the operation efficiency of goods handling in the warehouse, industrial trucks with double loading capacity have been developed, for example a so called support arm stacker with double loading capacity. In this type of truck a first load is lifted on a first set of forks which are movable on a mast. A second load is thereafter lifted on the support arms of the truck which are arranged to be elevated a small distance on the support wheels arranged under the arms. Since the support arms and the support wheels has to fit into the openings of the pallet, this type of truck can only be used for lifting pallets of large height dimensions.

Another type of truck with double loading capacity is provided with two forks which can be raised and lowered independently. The double forked truck loads one pallet on the first forks and raises thereafter the pallet on the mast and loads another pallet on the second forks. Thereafter the truck can transport the two pallets to a loading/unloading platform. A double forked truck is described in DE 20 2005 015 354 U1. In the known truck, both load carriages are on the same mast, the lifting mechanisms of the load carriages being arranged vertically displaced from each other. A problem with the known double forked truck is that the first load carriage needs to be large in order to be lowered to the same level as the second load carriage. This adds weight to the mast. When loads are lifted on both forks the load strains the mast which may cause problems of deforming of the mast.

It is an object of the present invention to provide an improved industrial truck which solves the aforementioned problems.

### SUMMARY OF THE INVENTION

The aforementioned object is achieved by the industrial truck according to independent claim 1. Further embodiments are disclosed in the independent claims.

The invention relates to an industrial truck comprising a first mast comprising two uprights and a first and a second load carriage arranged to be independently moved in the vertical direction wherein a second mast is arranged between the uprights of the first mast. The arrangement of two masts provides for a compact and flexible truck and enables the lifting of two separate loads without straining the components of the truck.

In particular, the first load carriage is supported on the first mast and arranged to be moved along the first mast. The second load carriage is supported on the second mast and arranged to be moved along the second mast.

The second mast may be attached to the truck motor housing, whereby the strain on the mast is minimized.

According to one alternative the length of the second mast is equal to or less than the height of the first mast.

According to a second alternative the length of the second mast is equal to or less than the height of the truck motor housing.

The second mast may comprise two U-shaped beams arranged with their openings facing each other, wherein the second load carriage is journalled in a space defined between the U-shaped beams. Such a mast may readily be arranged between the uprights of the first mast, thereby providing for a stable and compact mast arrangement.

The first load carriage could be arranged to pass outside the second load carriage. Thereby is achieved that load engaging means attached to the load carriages may be raised or lowered to the same height. The load engaging means may thereby easily be positioned in front of the openings of a load carrier. Particularly, it is possible to lower the load carriages to a position where the undersides of the load engaging means are in contact with the ground or close to the ground. By the arrangement it is possible to lift pallets of low height dimensions as long as the thickness of the load engaging means does not exceed the opening in the pallet

In particular, the first load carriage may comprise two protruding attachments which are journalled in the first mast.

In particular, the width of the second load carriage may be less than the distance between the attachments.

Alternatively, the first and the second load carriages comprise load carrying means, such as forks.

The first forks may be arranged to be lowered until they are level with the second forks.

### BRIEF DESCRIPTION OF THE DRAWINGS

FIG. 1 is a perspective view of an industrial truck according to the invention.

FIG. 2A and 2B are front and side views of the industrial truck according to the invention with both forks in a lowered position.

FIG. 2C and 2D are front and side views of the industrial truck according to the invention with the first forks in a raised position and the second forks in a lowered position.

FIG. 3 is view through the line B—B of FIG. 2C.

FIG. 4 is a top view of the industrial truck according to the invention.

FIG. 5 describes a cross-section of the second mast.

### DETAILED DESCRIPTION

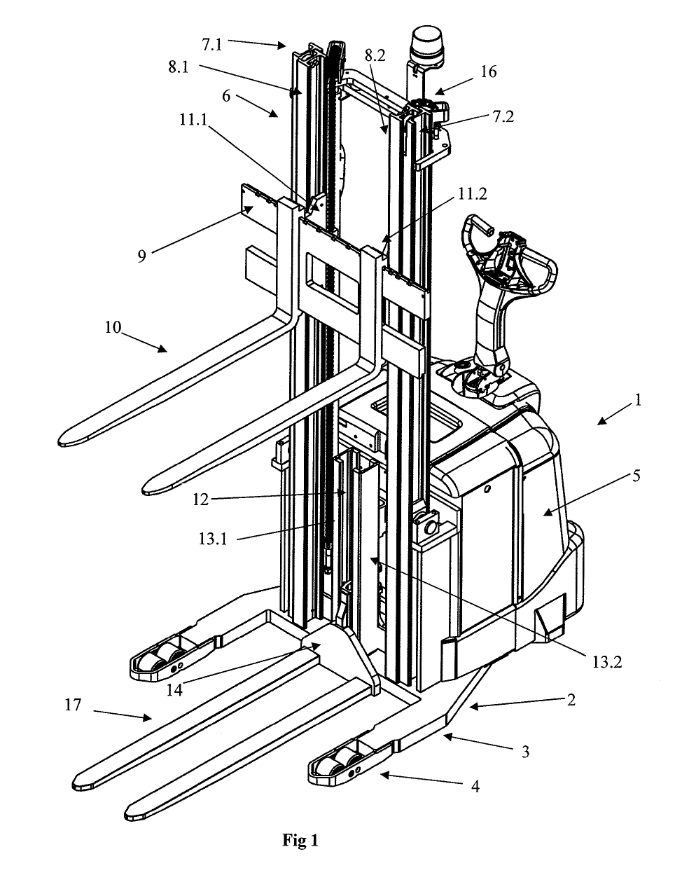

FIG. 1 describes an industrial truck according to the invention. The truck could be any type of industrial truck such as a fork lift truck, a stacking truck or a reach truck.

The industrial truck 1 comprises a frame 2. The forward part of the frame 2 extends into two support arms 3 on which support wheels 4 are arranged. The rear part of the frame supports a motor housing 5 in which electrical motors and hydraulic systems are accommodated (not shown). An electrical motor drives a drive wheel, arranged under the frame (not shown). The hydraulic system powers the raising and lowering of the load carriages of the truck, as explained further below. The truck may also comprise a space for the driver, such as a seat or a platform, as well as means for steering the truck e.g. a steering handle or a steering wheel.

The truck further comprises a first lifting mast 6. The mast could be either a fixed mast or a telescopic mast. In the case of a fixed mast, the mast comprises one pair of uprights 7.1, 7.2. Normally, the first mast is arranged on a forward part of the frame, in front of the motor housing. The lifting mast 6 comprises a load carriage 9 on which load engaging means 10 e.g. forks or can be attached. The load carriage 9 is attached to two attachments 11.1; 11.2 which are journalled in the uprights of the mast. The load carriage is arranged to be raised and lowered by a chain and pulley system 16 in a known manner.

In the case of a telescopic mast, a pair of inner uprights 8.1, 8.2 are arranged inside the outer uprights 7.1; 7.2. The inner uprights are journalled in the outer uprights. Further pairs of journalled uprights could be included in the telescopic mast. A hydraulic lifting arrangement, powered by the hydraulic motor is arranged to lift the inner uprights in order to extend the mast to a desired height. The load carriage 9, as described above, is attached to two attachments 11.1; 11.2 which are journalled in the innermost upright of the mast.

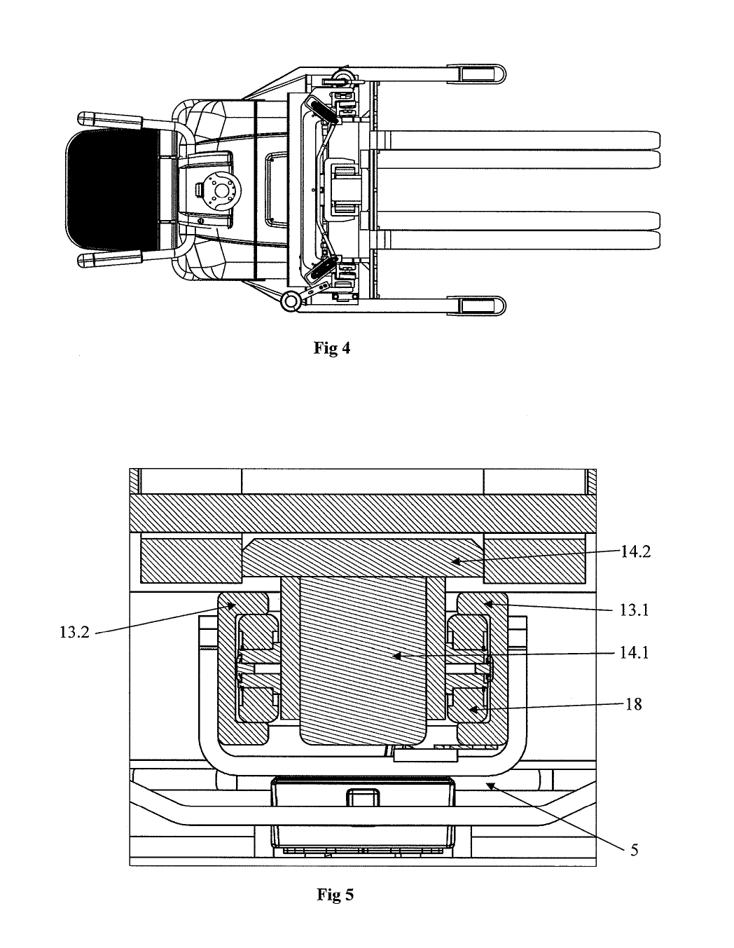

The industrial truck further comprises a second mast 12. The second mast 12 is arranged between the uprights of the first mast 6 on a forward part of the frame 2 in front of the motor housing 1. Normally, the second mast 12 comprises two uprights 13.1, 13.2, for example in the form of U-shaped beams. Each beam may be supported on its butt end on the frame 2 and fixed to the motor housing, e.g. by bolts. As described in FIG. 5, the beams 13.1 and 13.2 are arranged in a manner so that the legs of the beams are turned against each other and spaced a distance d from each other.

The second mast 12 comprise a second load carriage 14 on which second load carrying means 17, such as forks may be arranged. FIG. 5 shows a cross-section of the second mast 12. A first part, 14.1 of the second load carriage 14 is provided with rollers 18, which journals the load carriage on the inner surface of the beams. A second part, 14.2 to which the forks may be attached, extends in front of the mast 12.

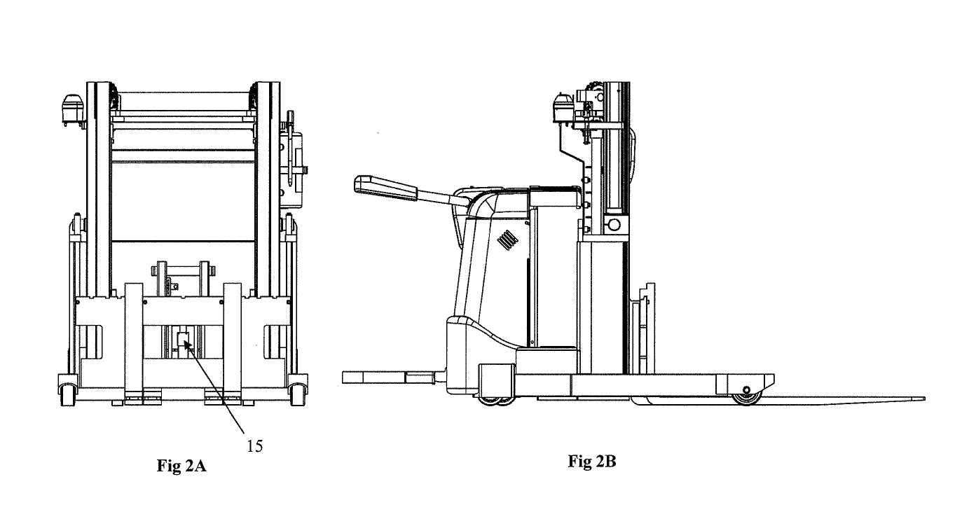

The load carriage 14 can be raised and lowered on the second mast 12 by means of a hydraulic lifting and lowering cylinder 15 shown in FIGS. 2A and 2C. The second mast 12 should be of a height less than or equal to the first mast, for example the height of the second mast could be equal to the height of the motor housing. The second mast could be attached to the motor housing at the upper and lower parts of the mast.

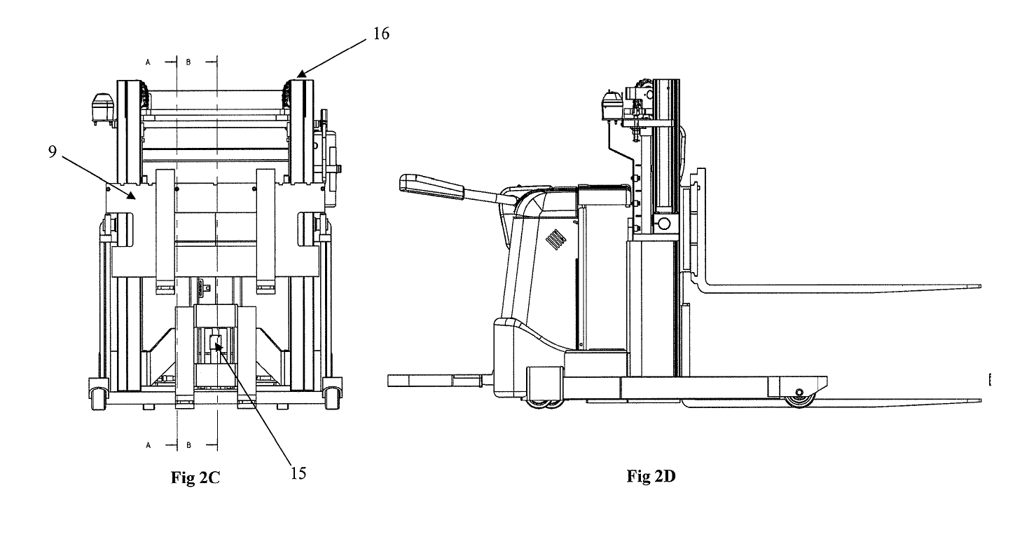

FIG. 3 describes a longitudinal cross-section of the industrial truck. As can be seen in FIG. 3, the attachments 11.1, 11.2 of the first load carriage 9 protrude horizontally from the mast. The attachments 11.1, 11.2 protrude such a distance so that the first load carriage, when fixed to the attachments, is located outside the second load carriage.

By the above described arrangement of load carriages and forks is achieved that when the first load carriage 9 is lowered, it passes outside the second load carriage 14, which fits between the attachments 11.1, 11.2 of the first load carriage. The first forks 10 may thereby be positioned at the same height as the second forks 17, thus in a position where the forks are level, see FIG. 2B. By this arrangement the forks may easily be positioned in front of the openings of a load carrier. Particularly, it is possible to lower both forks to a position where the undersides of both of the forks are in contact with the ground or close to the ground. By the arrangement it is possible to lift pallets of low height dimensions as long as the thickness of the forks does not exceed the opening in the pallet. For example, if the forks have a maximum thickness of 30 mm it is possible to insert them in a pallet which has a 30 mm high opening. Obviously, the forks could be of any thickness, since the dimensions of the forks are determined by parameters such as the material of the forks and the weight that should be lifted.

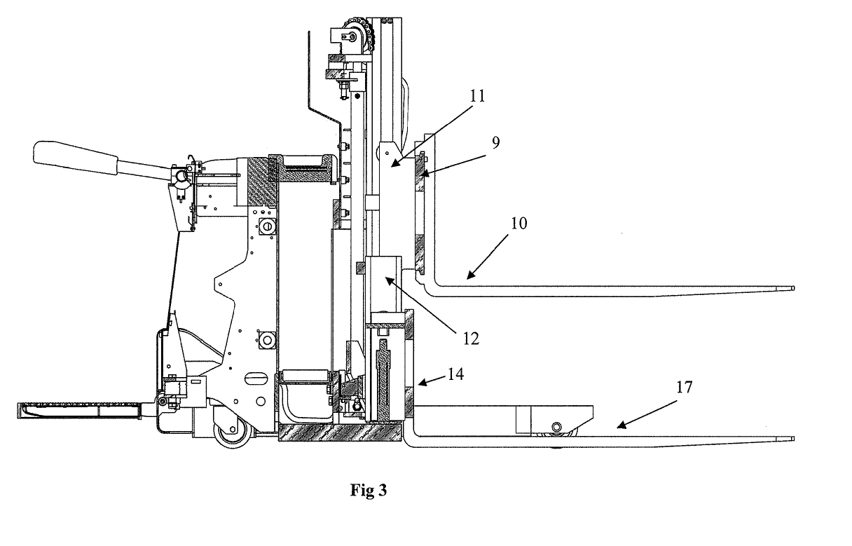

The first and the second forks should be arranged on each loading carriage so that the inner distance between the first forks is greater than the outer distance between the second forks as described in FIG. 4.

Following is an example of a lifting procedure, using the industrial truck according to the invention. First, the second forks are lowered to lowermost position, thus a position where the underside of the forks is in contact with the ground or close to the ground. Second, the first forks are lowered to the lowermost position, thus a position where the underside of the forks is in contact with the ground or close to the ground. The first and second forks are now located at the same height, the second forks are located between the first forks. Both forks are then inserted into the openings of a first pallet. Thereafter the first forks are raised on the mast, thereby lifting the pallet. Next, the second forks are inserted into the openings of a second pallet. The second forks are then raised a distance, thereby lifting the second pallet. The first pallet is lifted to a height somewhat higher than the height of the goods on the second pallet when raised by the second forks. The two pallets may now be transported by the truck.

1. Industrial truck (1) comprising a first mast (6) comprising two uprights (7.1, 7.2) and a first and a second load carriage (9; 14) arranged to be independently moved in the vertical direction characterized in that a second mast (12) is arranged between the uprights (7.1; 7.2) of the first mast (6).

2. Industrial truck (1) according to claim 1, wherein the first load carriage (9) is supported on the first mast (6) and arranged to be moved along the first mast (6); wherein the second load carriage (14) is supported on the second mast 12 and arranged to be moved along the second mast (12).

3. The industrial truck according to claim 1 or 2, wherein the second mast (12) is attached to the truck motor housing (5).

4. The industrial truck according to claim 3, wherein the length of the second mast (12) is equal to or less than the height of the first mast (6).

5. The industrial truck according to claim 4, wherein the length of the second mast (12) is equal to or less than the height of the motor housing (5).

6. The industrial truck according to any preceding claim wherein, the second mast (12) comprises two U-shaped beams (13.1; 13.2) arranged with their openings facing each other, wherein the second load carriage (14) is journalled in a space defined between the U-shaped beams.

7. The industrial truck according to any preceding claim, wherein the first load carriage (9) is arranged to pass outside the second load carriage (14).

8. The industrial truck according to claim 7, wherein the first load carriage (9) comprises two protruding attachments (11.1, 11.2) which are journalled in the first mast (6).

9. The industrial truck according to claim 8, wherein the width of the second load carriage is less than the distance between the attachments (11.1, 11.2).

10. The industrial truck according to any preceding claim, wherein the first and the second load carriage comprise load carrying means (10;17) such as forks.

11. The industrial truck according to claim 10, wherein the first forks are arranged to be lowered until they are level with the second forks.
